(19) United States
(12) Patent Application Publication
(10) Pub. No.: US 2002/0071957 A1
(43) Pub. Date: Jun. 13, 2002

(54) Method of refurbishing & on board scratch removal of glass on vehicles and scratch resistant assembly

(76) Inventor: John Squitieri, Suffern, NY (US)

Correspondence Address: RICHARD A. JOEL, ESQ., 496 KINDERKAMACK ROAD, ORADELL, NJ, 07649, US

(21) Appl. No.: 09/732,048

(22) Filed: Dec. 8, 2000

(51) Int. Cl. B32B 17/10

(52) U.S. Cl. 428/442; 427/140

(57) ABSTRACT

This invention comprises a method of refurbishing and removal of scratches from glass and a glass assembly which is resistant to scratches. The scratched glass is sanded to remove scratches and, after application of a bonding pumer and mounting of gasket a preheated acrylic is applied. After curing a polyvinyl sheet is applied to protect the acrylic. The process can be applied to “on board” repair of scratched glass on public vehicles.

### BACKGROUND OF THE INVENTION

### FIELD OF THE INVENTION

This invention relates to a protective coating assembly for glass and methods for refurbishing and on board scratch removal of glass on public transportation vehicles, such as trains, buses or trolleys. The invention discloses a method for repairing glass which has been damaged by what is called “scratchitti”, the intentional damaging or scratching of glass by vandals.

### DESCRIPTION OF THE RELATED ART INCLUDING INFORMATION DISCLOSED UNDER 37 CFR §§ 1.97-1.98

This invention relates to the repair of glass, particularly on public transportation vehicles. In urban areas one of the “quality of life” battlegrounds is preserving trains, buses, etc. from grafitti and lately from scratchitti. Vandals scratch glass windows with sharp implements marring the view and disturbing the vehicle occupants with their threatening and banal scratch marks. The municipal authorities have spent considerable sums replacing scratched glass damaged by vandals.

Replacing glass on vehicles is quite expensive since, more often than not; it has to be done in the field. Taking a vehicle out of operation for a prolonged period is not a viable option Consequently, there is a need for a fast, inexpensive method to repair scratched glass.

### SUMMARY OF THE INVENTION

This invention relates to a method of repairing scratched glass, either manually or automatically, by first sanding said glass to remove the scratches. After the glass is sanded and dried, a bonding primer is applied and then a gasket strip is mounted thereto to obtain the required coating thickness and spacing for placement into a window frame. Next, an acrylic coating is applied by “flood coating” pre-heated acrylic at 125° F. The acrylic is cured with a dual fusion type of UV lighting system for deep and surface curing. Finally, a polyvinyl sheet ranging from 0.010″ to 0.015″ thick is applied atop the cured acrylic base coat to protect the acrylic base coat from scratching. The polyvinyl sheet may be readily removed and repair does not have to be made to the acrylic unless the scratching penetrates through the vinyl sheet.

To perform an onboard repair of scratched glass, the polyvinyl sheet is removed and if the scratches have penetrated the base coated acrylic a random orbital sander is used to remove the scratches. After sanding, the acrylic coating is buffed and polished with a polishing compound. In a first pass, the operator concentrates on the peripheral outline of the sanded portion of the window where the scratch is removed using a solid compound bar. Next, using a sponge, a liberal amount of paste is applied across the surface area that was sanded. Next, using a a sponge, a liberal amount of a different paste is applied across the surface area that was sanded and polished with the DD3 paste. All traces of the 2L paste compound are polished away. Next, using a sponge, a liberal amount of HN3 paste is applied on the surface area. All traces of the HN3 paste are polished away using a lamb's wool pad. Finally, using a sponge, a liberal amount of PO3 paste is applied across the surface area that was sanded and polished with HN3 paste. All traces of PO3 paste are polished away. A foam buffing pad is used. The on board repair process is now finished and the vehicle is placed back into service, or if necessary, another polyvinyl sheet is applied thereto.

In the procedure described above, a completely uniform thickness of the acrylic must be obtained across the surface of the glass. This acrylic coating must be of sufficient thickness so that vandals cannot penetrate through it and damage the underlying glass and secondly, it must be of uniform thickness to obtain perfect optical clarity, permitting distortion free vision. Another feature of the invention is the “flood coating” of damaged glass with a glass draw rod, which hides all of the sanding marks and provides a restored piece of glass that has a repairable coating, as well as perfect distortion free clarity.

Accordingly, the object of this invention is to provide a new and improved method for repairing scratched glass.

Another object of this invention is to provide a new and improved method for refurbishing and on board scratch removal of glass on public transportation vehicles, which are damaged by scratches.

Another object of this invention is to provide a new and improved glass assembly, which is resistant to scratches.

A more specific object of this invention is to provide a new and improved method and design for repairing scratched glass which includes sanding, applying an acrylic coating and applying a polyvinyl sheet on top of the acrylic base coat for additional protection.

A further specific object of this invention is to provide a new and improved method and design for repairing existing scratched glass, particularly on public vehicles, which includes sanding of glass, applying a bonding primer, mounting a gasket thereto, applying an acrylic coating and curing said coating and applying a polyvinyl sheet atop of the acrylic base coat for additional protection.

### BRIEF DESCRIPTION OF THE DRAWINGS

The above and other objects of the invention may be more readily seen when viewing in conjunction with the accompanying drawings wherein:

FIG. 1 is a top view of the glass structure and protective coatings; and

FIG. 2 is a flow chart illustrating the method of repairing damaged glass, and;

FIG. 3 is a flow chart illustrating the on board repair process for damaged glass.

### DETAILED DESCRIPTION OF THE INVENTION

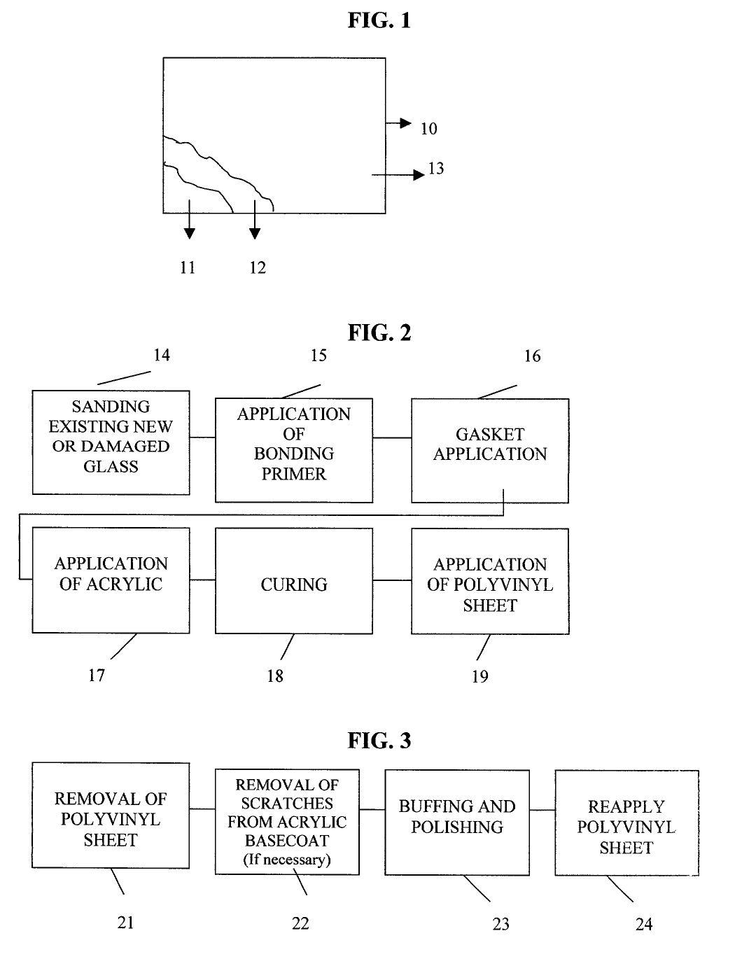

Referring to FIG. 1 of the drawings, the glass assembly 10 comprises a base layer of glass 11 which includes a layer of acrylic 12 0.015″ to 0.030″ thick which is mounted thereon and cured in a horizontal position and a top layer 13 of polyvinyl, ScotchShield™, or Mylar which is intended to protect the acrylic coating. The polyvinyl, ScotchShield™, or Mylar 13 is applied as a sheet and may be readily removed from the acrylic base. The purpose of the sheet of polyvinyl, ScotchShield™ or Mylar 13 is to protect the acrylic sheet from scratching which requires a greater repair effort. The sheet 13 is approximately 0.007″ to 0.015″ thick and is designed to protect the base coat 12 from significant scratch damage to reduce the amount of sanding and buffing required to remove scratches from the acrylic coating.

The first step in the refurbishing of new or damaged glass is sanding 14. 400 grit sanding paper is required for the initial sanding if scratches are present while 120 grit will suffice for new glass with no scratches. The sanding can be done either with manual or automatic equipment. A four-inch wide belt sander with accompanying silicon carbide paper is used for manual hand sanding preferably with a bag for fine dust. The sander must be moved across the glass at all times so that the glass does not overheat and crack. Further, the entire surface area of the glass needs to be sanded so as to promote the strongest possible bonding of acrylic to glass. The use of a cleaning stick is recommended. The stick is of gum rubber and is designed to remove the fine glass particles from the glass. After sanding, the glass is cleaned by water-dampened towels to remove glass particles. Next, the glass is dried by use of an infrared heater.

In Step 2, an application of bonding primer 15 is applied. The primer is applied in a very light film, using a dust and lint free cloth. The non-solvent primer is allowed to dry over a pre-determined period of time in the range of five minutes and infrared lighting can be used to speed up the drying process.

In the next step (gasket application) 16, pre-cut ⅜″ wide gasket strips of neoprene rubber with a pressure sensitive backing, are used to obtain the required coating thickness and spacing for placement into the window frame. The gaskets are mounted and the thickness of the rubber is variably dependent upon the required coating thickness.

In step 15 the glass is “flood coated” with pre-heated acrylic at approximately 125° F. at the rate of 5 oz. per square foot. The acrylic is preheated in one-liter bottles in a standard laboratory warming oven. The glass is placed inside a special trough that is designed to capture the acrylic and it is designed so that any excess acrylic falls off the sides and ends of the glass when the excess is removed with a glass draw rod. The glass itself is mounted horizontally upon a pedestal inside the trough.

The glass, which is mounted in the trough, is leveled with a bubble gauge on the pedestal. The appropriate amount of acrylic is poured into the well area of the glass that has been created by placement of the rubber gaskets around the edges. Half of the acrylic is slowly poured vertically down the length of the glass and the other half is poured horizontally across the glass, approximately one inch apart. The acrylic includes leveling and air release agents so that when the acrylic is 125° F., it will flow into itself. A one-half inch solid glass draw rod, which is wider than the glass being worked on, is drawn slowly down the length of the glass. Excess acrylic is removed, falling off the sides of the rod, as it moves across the length of the glass. The glass at the opposite end from where the rod started, falls into the trough where it can be reclaimed and reused. The drawing results in a coating of the required thickness without distortion.

Next, a curing step 16 takes place wherein the acrylic is cured with a fusion type of UV lighting system for deep and surface curing. Preferably, a conveyor system which will accommodate glass up to 48″ wide is used, With the glass placed on the automatic feed, the conveyor passes the glass under a series of curing bulbs set at various heights to insure complete curing in a minimum of time. The initial bulb will be a type D bulb for deep curing and hereafter the glass passes under an H bulb for surface curing. After the acrylic has been cured the rubber gaskets are peeled off and discarded and the glass is ready to be reinstalled.

All of the above processes 14 15 16 17 18 may be performed automatically or manually. The final step 19, which is recommended, is the application of an additional protective coating to a polyvinyl sheet 19. The thickness of the polyvinyl sheet should prevent any damage on the acrylic base coat since the polyvinyl sheet will take the brunt of any scratching done by vandals. A recommended coating is ScotchShield™ by 3M Company which is an ultra high performance safety security film. If any scratches do penetrate the polyvinyl and damage the acrylic base coat, the scratches can be sanded and buffed out of the acrylic and once completed, another sheet of polyvinyl can be applied on top of the acrylic base coat. The polyvinyl sheet is applied by separating the film from a backing sheeting by peeling them apart with the backing piece being discarded and the protective film being applied to the acrylic coating. The adhesive side of the protective film is spray washed with plain water to activate the glue that bonds the polyvinyl to the acrylic. The surface of the acrylic is sprayed with plain water and the polyvinyl sheet is applied. Excess water is squeegeed out from underneath the polyvinyl to make a perfectly smooth and distortion free assembly. Once all water and air pockets are removed with a squeegee, the polyvinyl sheet will begin to adhere to the surface of the acrylic as the glue hardens over a period of time, usually about twenty-four hours.

FIG. 3 discloses an on board repair process wherein removal of the polyvinyl sheet occurs in Step 1, the removal of scratches from the acrylic base coat occurs in 22 and the buffing and polishing 23 occurs last.

The polyvinyl sheet 13 is removed from the acrylic by peeling off the sheet from the corners and if the scratches have not penetrated the film and damaged the underlying acrylic, one simply repeats the process to reapply the film.

On the other hand if the scratches are so deep that they have completely penetrated the polyvinyl sheet and damaged the acrylic layer, scratches are removed as in Step 14 by sanding. Once all scratches have been removed and the acrylic rebuffed to its original clarity, the polyvinyl sheet is reapplied.

In Step 22, a random orbital sander (6″ or8″ sanding surface for use with Velcro® sanding pads with a vacuum dust collector, is generally used for sanding. The operator would begin with 400 grit sandpaper to remove scratches and the operator advances up to the next grit 600.

After the 600 grit sanding step has been repeated, the operator repeats the sanding process using 15 micron paper. Care and time must be taken when feathering out the 600 grit sanding marks.

Grinding, buffing and polishing is required with either an electric or air-driven polisher with a 7″ drive block that turns at 2500 rpm minimum and 10,000 rpm maximum. Various polishing pads are used in order with the first being a one inch pile lamb's wool pad, the next a ripple foam polish pad and the final pad is an open weave polishing pad. Four different polishing pastes are used in conjunction with the lamb's wool and foam pads. All are manufactured by Menzerna-Werk and are designed for polishing acrylics. In order of grit from coarsest to finest they are: DB3, 2L, HN3, PL32. The various pastes and polishes are used to provide a smooth distortion free view through the coated glass surface. Other comparable pastes and polishes may be used to replace Menzerna-Werk's pastes and polishes.

While the invention has been explained by a detailed description of certain specific embodiments, it is understood that various modifications and substitutions can be made in any of them within the scope of the appended claims, which are intended also to include equivalents of such embodiments.

What is claimed is:

1. The method of repairing and protecting scratched glass comprising the steps of:
sanding the scratched glass to remove the scratches;
applying a bonding primer to the sanded glass;
mounting a gasket strip about the glass;
applying an acrylic coating over the glass;
curing the acrylic coating with a UV lighting system; and
applying a polyvinyl sheet over the cured acrylic coating to protect the acrylic coating from scratching.

2. The method of repairing and protecting scratched glass in accordance with claim 1 wherein:
the acrylic coating is preheated to approximately 125° F. and flood coated over the glass.

3. The method of repairing and protecting scratched glass in accordance with claim 1 wherein:
the curing of the acrylic coating comprises using a dual fusion type of UV lighting system for deep and surface curing.

4. The method of repairing and protecting scratched glass in accordance with claim 1 wherein:
the glass comprises a sheet of predetermined dimensions having peripheral edges and, wherein the gasket strip is mounted about the peripheral edges of the glass to provide a predetermined acrylic coating thickness.

5. The method of repairing and protecting scratched glass in accordance with claim 1 wherein:
the acrylic layer ranges in depth from 0.015 to 0.030 inches.

6. The method of repairing and protecting scratched glass in accordance with claim 1 wherein:
the scratched glass is sanded with 120 grit sandpaper.

7. The method of repairing and protecting scratched glass in accordance with claim 1 further including the steps of:
using a gum rubber cleaning stick to remove fine glass particles from the sandpaper;
cleaning the glass with water dampened towels to remove glass particles; and, drying the glass with an infrared heater.

8. The method of repairing and protecting scratched glass in accordance with claim 1 wherein:
the acrylic coating is flood coated at a rate of approximately five ounces per square foot.

9. The method of repairing and protecting scratched glass in accordance with claim 1 wherein:
the gasket strip is ⅜ inches wide, of neoprene rubber and includes a pressure sensitive backing for mounting purposes.

10. The method of repairing and protecting scratched glass in accordance with claim 1 wherein:
applying the acrylic coating includes the steps of pouring about half the acrylic vertically down the length of the glass and pouring half of the acrylic horizontally across the glass in lines approximately one inch apart; and,
leveling the acrylic coating with a glass draw rod.

11. The method of repairing and protecting scratched glass in accordance with claim 1 wherein:
the curing includes passing the glass under a series of curing bulbs at various heights, said initial bulbs being type D bulbs for deep curing and thereafter passing the glass under Type H bulbs for surface curing.

12. The method of repairing and protecting scratched glass in accordance with claim 1 wherein:
the polyvinyl sheet includes an adhesive backing, said polyvinyl sheet being removed from a backing sheet for application to the acrylic coating.

13. The method of repairing and protecting scratched glass in accordance with claim 1 wherein:
the polyvinyl, Scotchshield™ or Mylar sheet is applied over the cured acrylic coating to protect the acrylic coating from scratches.

14. The method of repairing and protecting scratched glass in accordance with claim 1 further including the steps of:
spray washing the adhesive backing to activate the adhesive;
spraying the acrylic surface with water;
applying the polyvinyl sheet to the acrylic surface, and
forcing the water out from under the polyvinyl sheet to provide a smooth and distortion free assembly.

15. The method of repairing a scratched glass assembly including a glass bond having an acrylic coating and a polyvinyl sheet bonded thereto comprising the steps of:
removing the polyvinyl sheet from the acrylic coating on the glass by peeling off the bonded sheet from the corners;
sanding any scratches from the acrylic coating layer; and
buffing and polishing the acrylic to its original clarity; and
applying a new polyvinyl sheet to the acrylic coating on the glass.

16. The method of repairing and protecting scratched glass in accordance with claim 14 wherein:
the scratches are removed by sanding the acrylic coating with 400 grit sandpaper, then sanding with 600 grit sandpaper and finally with 15 micron paper to provide visually clear surface.

17. The method of repairing and protecting scratched glass in accordance with claim 15 wherein:
grinding, buffing and polishing are performed by a seven inch drive block; and the polishing involves a series of polishing pads, the first pad being a one inch pile lamb's wool pad, the next pad being a ripple foam polish pad and the final pad being open weave polishing pad; and

18. The method of repairing and protecting scratched glass in accordance with claim 16 wherein:
three different polishing pastes are applied, one with each of the various polishing pads, said pastes varying in consistency to provide a progressively more polished finish.

19. A glass assembly which is resistant to scratches comprising:
glass sheet having an upper surface and peripheral edges,
an acrylic coating, having a thickness of 0.015 to 0.030 inches, bonded to the upper surface and cured thereon; and
a polyvinyl sheet having an adhesive backing mounted to the acrylic coating with said adhesive.
